(19) United States
(12) Patent Application Publication
(10) Pub. No.: US 2013/0141366 A1
(43) Pub. Date: Jun. 6, 2013

(54) MEDICAL IMAGE-BASED INFORMATION SYSTEM AND MOBILE MULTITOUCH DISPLAY DEVICE

(71) Applicant: Fraunhofer-Gesellschaft zur Foerderung der ange, Munchen (DE)

(72) Inventors: Felix Ritter, Bremen (DE); Markus Harz, Lilienthal (DE)

(73) Assignee: Fraunhofer-Gesellschaft zur Foerderung der angewandten Forschung e.V., Munchen (DE)

(21) Appl. No.: 13/684,083

(22) Filed: Nov. 21, 2012

(30) Foreign Application Priority Data
Nov. 25, 2011 (DE) 102011087150.0

(51) Int. Cl. G06F 3/041

(52) U.S. Cl. CPC G06F 3/041
USPC 345/173

(57) ABSTRACT

Methods, systems, and techniques for an medical image-based information system are provided. The medical image-based information system comprises: a processing unit for providing medical image data and interactive functions for interacting with the medical image data; one or more image data display devices for displaying the medical image data provided by the processing unit; and a mobile multi-touch display device. The medical image-based information system is adapted to display the medical image data provided by the processing unit on an image data display device of the one or more image data display devices and to make the interactive functions provided by the processing unit available to a user via the mobile multi-touch display device. The medical image-based information system can be operated in a simple, flexible and space-saving manner via the mobile multi-touch display device.

### TECHNICAL FIELD

The present disclosure relates to methods, techniques, and systems for a medical image-based information system and a mobile multi-touch display device for use in said medical image-based information system.

### BACKGROUND

Medical image-based information systems are used in the clinical environment to manage medical image data of patients and to provide them to medical staff for diagnostic purposes, for planning treatment, preparing surgical operations, etc. The systems available today mostly include a central processing unit for providing the medical image data, and decentralized processing units for holding a selected subset of all the available medical image data and for providing functions for interacting with the medical image data. The decentralized processing units show the medical image data on one or more image data display devices, for example on a high-resolution, certified monitor on a radiological workplace computer, and interaction with the displayed medical image data is done by means of customary peripheral devices in the form of a keyboard and mouse. This is disadvantageous, however, because the necessary interactions in the clinical environment are complex and often spatially oriented, such as marking possible lesions or tumors in a three dimensional (3D) image data set, and in many cases can only be achieved with difficulty with just a keyboard and a mouse. Furthermore, a table is usually provided, on which the devices for interaction are placed and on which the mouse, in particular, can be moved and thus put to use. This costs space and also imposes unnecessary limits on the freedom of movement of the user, who generally has to sit on a chair at the table.

Patent specification EP 2 031 531 A2 relates to a medical display system comprising an image display unit which is configured to display image data of medical or medical technological origin, and further comprising an additional device which is integrated in the system comprising the image display unit and which supports the medical function of the image display unit.

German laid-open patent application DE 10 2009 018 424 A1 relates to a method for outputting medical documents on an input/output unit (AE) with a multi-touch function.

### BRIEF DESCRIPTION OF THE DRAWINGS

FIG. 1 shows a first embodiment of a medical image-based information system, in schematic form and by way of example.

FIG. 2 shows a second embodiment of a medical image-based information system, in schematic form and by way of example.

FIG. 3 shows an embodiment of a mobile multi-touch display device, in schematic form and by way of example, for use in the medical image-based information system according to the first embodiment shown in FIG. 1.

FIG. 4 shows, in schematic form and by way of example, an embodiment of a mobile multi-touch display device for use in the medical image-based information system according to the second embodiment shown in FIG. 2.

FIG. 5 shows a third embodiment of a medical image-based information system, in schematic form and by way of example.

### DETAILED DESCRIPTION

Embodiments described herein provide enhanced computer- and network-based methods, techniques, and systems for a medical image-based information system and a mobile multi-touch display device for use in said medical image-based information system.

According to a first aspect, a medical image-based information system is provided, the medical image-based information system comprising:
a processing unit for providing medical image data and interactive functions for interacting with the medical image data;
one or more image data display devices for displaying the medical image data provided by the processing unit; and
a mobile multi-touch display device,

wherein the medical image-based information system is adapted to display the medical image data provided by the processing unit on an image data display device of the one or more data display devices and to make the interactive functions provided by the processing unit available to a user via the mobile multi-touch display device.

The disclosure is based on the idea of providing a medical image-based information system in which interaction with the medical image data is not performed using the normal peripheral devices, namely a keyboard and mouse, but by using a mobile multi-touch display device, thus allowing one to dispense with a keyboard and mouse. This is an advantage, particularly when the intention is to enable access to the medical image data on the medical image-based information system in the patient's room or in an operating theater, where there is not usually much space to install a table for a keyboard and mouse. With the present invention, an image display device of the medical image-based information system could be fixedly installed on the wall of the patient's room or the operating theater, and during the rounds a physician or a nurse could have the patient's medical image data displayed on the fixedly installed image display device with the aid of the mobile multi-touch display device, and interact with these image data, for example to explain more clearly to patients the details of their illnesses by referring during the bedside conversation to enlarged sections of the images.

In the context of the present application, the expression “medical image data” includes digital images of a patient that are obtained, for example, by means of medical imaging techniques during one or more examinations of the patient. Examples include computer tomography (CT) scans, X-rays, positron emission tomography (PET) scans, endoscopic images, ultrasound scans and magnetic resonance imaging (MRI) scans. The medical image data are usually available in a secured, centralized image data archive, which may be part of the medical image-based information system, or to which the medical image-based information system has access via an appropriate communication channel, for example a wired or wireless network connection. The medical image data can basically be produced in analog form as well, then digitized in a suitable way for use in the medical image-based information system. In the context of the present application, the expression “medical image data” includes not only single images, but also series of images and videos, and not only two-dimensional (2D), but also three-dimensional sets of image data, or even, in the case of MRI scans enhanced by a contrast agent, four-dimensional (4D; space+time) sets of image data.

An “image data display device” is understood in the context of the present disclosure to be a display device that is provided in a clinical environment to display the medical image data made available by the processing unit. The display device can comprise, for instance, one monitor or several monitors. A monitor of a display device can be, for instance, a high-resolution, certified monitor for a radiological workplace computer, for example, or it can also be a less high-quality monitor in a patient's room, or a beamer in a medical consultation room. If a display device comprises several monitors, they can be arranged in a setup that is intended to fulfill a certain predefined application task. For example, for mammography screening, there is usually one small color monitor in landscape orientation to display patient information and enter the diagnostic report, and two high-resolution calibrated monitors in portrait orientation to display the mammograms.

The term “multi-touch display device” refers, in the context of the present application, to an electronic display device comprising a touch-sensitive screen which is capable of detecting two or more points of simultaneous contact with the screen, for example with two fingers.

In some embodiments, the medical image-based information system includes an association unit for associating the mobile multi-touch display device with the image data display device of the one or more image data display devices. This association produces a “logical” assignment of the mobile multi-touch display device to the image data display device, so that the user can have the medical image data provided by the processing unit displayed on the image display device and can interact with those data by means of the interactive functions made available via the mobile multi-touch display device. In this way, the mobile multi-touch display device in the medical image-based information system can be used very flexibly with the image data display device that the user wants to use.

In some embodiments, the medical image-based information system is adapted to display, on the image data display device of the one or more image data display devices, an identifier assigned to said data display device, that the mobile multi-touch display device includes a camera unit for detecting the displayed identifier, and that the association unit is adapted to associate the mobile multi-touch display device with the image data display device of the one or more image data display devices on the basis of the detected identifier. In this way, the mobile multi-touch display device can be associated with the image data display device of the one or more image data display devices in a simple and flexible manner.

In some embodiments, the medical image-based information system includes a locating unit for identifying the location of the mobile multi-touch display device, and the association unit is adapted to associate the mobile multi-touch display device with the image data display device of the one or more image data display devices on the basis of the identified location. This allows the mobile multi-touch display device to be associated substantially automatically with the image data display device of the one or more image data display devices.

In some embodiments, the mobile multi-touch display device includes a sensor unit for detecting a biometric identifier of the user, and the medical image-based information system includes an authentication unit for authenticating the user on the basis of a comparison of the detected biometric identifier with stored biometric identifiers of users authorized to use the medical image-based information system. The detected biometric identifier may be a fingerprint identifier, an iris pattern identifier or a face identifier. By means of such authentication based on a registered biometric identifier of the user, the medical image-based information system can be better protected against unauthorized access to the medical image data than, for example, with authentication based on a user name and a password.

In some embodiments, users who are authorized to use the medical image-based information system can be classified into user classes, and the interactive functions made available to the user via the mobile multi-touch display device are dependent on the user class. This is advantageous for safety reasons, since it allows the available interactive functions to be made selectively accessible to certain user classes only (for example, it would be possible in this way to prevent certain analyses and diagnoses being performed with the medical image data by non-medical staff), and because users themselves are helped when not all the interactive functions are available, particularly those that are of no interest, thus enhancing the clarity and lucidity of the system.

In some embodiments, the medical image-based information system includes a de-authentication unit for automatic de-authentication of the user.

In some embodiments, the one or more image data display devices are classified into image data display device classes, and the interactive functions made available to the user via the mobile multi-touch display device are dependent on the image data display device class of the image data display device of the one or more image data display devices. The classification of the one or more image data display devices into the image data display device classes may be dependent on an operating environment in which one or more image data display devices are used, and/or on the image data display quality of the one or more image data display devices. This makes it possible, for example, to prevent medical image data (for example mammography scans) from being analyzed and diagnosed in a bright room or on a monitor with only low resolution. The classification can be a direct classification, wherein each image display device is directly assigned to a certain class. However, the classification can also be an indirect classification, wherein, for instance, assignments between technical characteristics of the image data display devices and classes are provided and wherein, since the technical characteristics of the image display devices are known, these assignments provide an indirect classification. If an image data display device comprises several monitors, the technical characteristics of these monitors can be used for providing the indirect classification of the image display device.

In some embodiments, the mobile multi-touch display device is adapted to receive an item of information from the processing unit about available patient data and to display this information in the form of a patient selection list for selection by the user. This allows a patient data record to be easily selected via the mobile multi-touch display device.

In some embodiments, the mobile multi-touch display device includes a touch-sensitive screen and is adapted to detect two or more points of simultaneous contact with the screen, and the medical image-based information system may be adapted to allow the user to perform the interactive functions made available to him via the mobile multi-touch display device by touching the screen.

In some embodiments, the mobile multi-touch display device includes a touch-sensitive screen and may be adapted to detect two or more points of simultaneous contact with the screen and to transmit the detected points of contact to the processing unit. This allows simple realization of the mobile multi-touch display device, since the required logic control, for example for deriving gestures assigned to interactive functions from the detected points of contact, can be substantially realized in the processing unit.

In some embodiments, the mobile multi-touch display device includes a touch-sensitive screen and may be adapted to detect two or more points of simultaneous contact with the screen, and the mobile multi-touch display device also may be adapted to display on the screen a number of independent areas of contact, each of which can be assigned to a subset of the interactive functions provided via the multi-touch display device.

In some embodiments, the mobile multi-touch display device is adapted to communicate with the processing unit via a wireless data communication link.

According to another aspect, a mobile multi-touch display device is provided for use in the medical image-based information system.

It should be understood that example embodiments may also comprise any combination of the dependent claims with the respective independent claim.

In addition, non-transitory and/or tangible computer-readable media containing instructions for controlling one or more computer processors to effectuate one or more of the functions described herein are also contemplated.

Also, methods for effectuating one or more of the functions described herein are also contemplated.

These and other aspects of the present disclosure shall now be described with reference to the Figures.

In the Figures, the same or corresponding units, elements, etc. are marked with the same reference signs. When a unit, an element, etc. has already been explained in more detail with reference to a particular figure, a detailed description is dispensed with when discussing another figure.

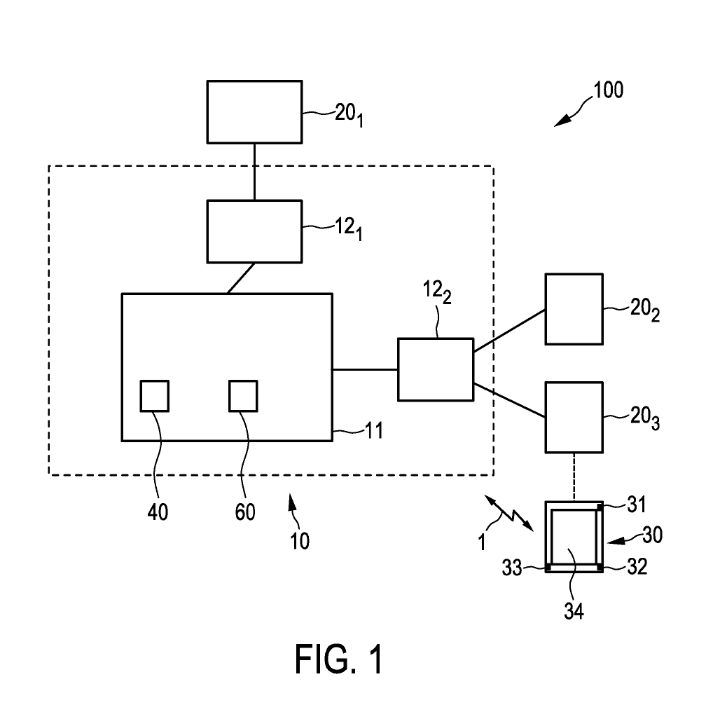

FIG. 1 shows, in schematic form and by way of example, a first embodiment of a medical image-based information system 100 (in the following description, also referred to sometimes in short as “MIBIS”). The MIBIS 100 comprises a processing unit 10 for providing medical image data and interactive functions for interacting with the medical image data. In this embodiment, processing unit 10 is implemented in the form of a central processing unit 11 and a number of decentralized processing units 12₁, 12₂, which are connected via a network (for example, a secure, wireless or wired local network) to central processing unit 11 (this is indicated in FIG. 1 by the broken line that surrounds central processing unit 11 and the decentralized processing units 12₁, 12₂). Central processing unit 11 includes a secure image data archive (not shown in FIG. 1), in which all the available medical image data of patients are stored. At the least, central processing unit 11 in this implementation provides interactive functions for accessing the available medical image data. The decentralized processing units 12₁, 12₂ connected to central processing unit 11 may be dedicated workplace computers, for example a workplace computer 12₁ in an operating theater, or a radiological workplace computer 12₂. These can communicate with central processing unit 11 via the network, for example to access medical image data in the secure image data archive. The decentralized processing units 12₁, 12₂ may include storage units (not shown in FIG. 1) for holding a selected subset of all the available medical image data and for providing further interactive functions for interacting with the medical image data held in storage. For example, workplace computer 12₁ provides, inter alia, interactive functions in the operating theater for fetching and controlling specific visualizations (e.g. for monitoring the surgical operation), and radiological workplace computer 12₂ provides, inter alia, interactive functions for analyzing and diagnosing the medical image data held in storage. It should be understood that the number of decentralized processing units 12₁, 12₂ is not limited to two, as in this example, but that a greater or smaller quantity of such units may be provided. Furthermore, processing unit 10 may also been realized differently, for example as a single (central) unit that provides the medical image data and all the interactive functions that are required. In the context of the present application, any one of the decentralized processing units 12₁, 12₂, for example, can also be viewed on its own as processing unit 10.

The medical image-based information system 100 also comprises one or more image data display devices 20₁, 20₂, 20₃ for displaying the medical image data provided by processing unit 10. In this example, a first image data display device 20₁ is provided at workplace computer 12₁ in the operating theater, and two other image data display devices 20₂, 20₃ are provided at radiological workplace computer 12₂. It should be assumed with regard to the following description that image data display devices 20₂, 20₃ at radiological workplace computer 12₂, are high-resolution, certified monitors, for example with a resolution of 8 megapixels and a diagonal screen size of 92 cm (36.22 inches). It should also be understood that the number of the one or more image data display devices 20₁, 20₂, 20₃ is not limited to three, as in this example, but that a greater or smaller quantity of such devices may be provided.

The medical image-based information system 100 further comprises a mobile multi-touch display device 30, i.e., an electronic display device comprising a touch-sensitive screen 34 which is capable of detecting two or more points of simultaneous contact with screen 24, for example with two fingers. The mobile multi-touch display device 30 is adapted to communicate with processing unit 10 via a wireless data communication link 1, for example a WLAN. Data are communicated wirelessly by means of secure data communication protocols for wireless communication, for example. The mobile multi-touch display device 30 has suitable transmission and receiving means for wireless data communication (not shown in FIG. 1); respective transmission and receiving means for wireless data communication are likewise provided in the region of processing unit 10, for example (likewise not shown in FIG. 1). The medical image-based information system (MIBIS) 100 is adapted to display the medical image data provided by processing unit 10 on an image data display device, for example on a high-resolution, certified monitor 20₃ at radiological workplace computer 12₂, of the one or more image data display devices 20₁, 20₂, 20₃, and to make the interactive functions provided by processing unit 10 available to a user via the mobile multi-touch display device 30. The MIBIS 100 thus permits the user to perform the interactive functions made available to him via the mobile multi-touch display device 30 by touching the screen. In this embodiment, mobile multi-touch display device 30 thus replaces the customary peripheral devices in the form of a keyboard and mouse. How this can specifically be done shall now be described in more detail with reference to an example.

A first step consists in associating the mobile multi-touch display device 30 with the image data display device 20₃ of the one or more image data display devices 20₁, 20₂, 20₃, i.e., to produce a “logical” assignment of the mobile multi-touch display device 30 to the image data display device 20₃, so that the user can have the medical image data provided by the processing unit 10 displayed on the image display device associated with the mobile multi-touch display device 30, in this case the high-resolution, certified monitor 20₃ at radiological workplace computer 12₂, and can interact with those data by means of the interactive functions made available via the mobile multi-touch display. For that purpose, the medical image-based information system 100 includes an association unit 40 for associating the mobile multi-touch display device 30 with the image data display device 20₃ of the one or more image data display devices 20₁, 20₂, 20₃. In this embodiment, association unit 40 is implemented as part of processing unit 10, for example by means of suitable software routines. Alternatively, association unit 40 may also be a separate unit.

In this embodiment, the association functionality described above is achieved by the medical image-based information system 100 being adapted to display on the image data display device 20₃ of the one or more image data display devices 20₁, 20₂, 20₃ an identifier (for example a unique identifier) assigned to said data display device. The identifier may be displayed in coded form, for example, using a “QR” (quick response) code, i.e., a two-dimensional barcode. Alternatively however, it is also possible to use a one-dimensional barcode, a sequence of numbers, an image, a word, or the like. In this case, mobile multi-touch display device 30 comprises a camera unit 31 for detecting the displayed identifier. The detected identifier is transmitted to association unit 40, which is adapted to associate the mobile multi-touch display device 30 with the image data display device 20₃ of the one or more image data display devices 20₁, 20₂, 20₃ on the basis of the detected identifier. It should be understood that when the identifier is displayed in the form of a QR code, for example, an implementation can be used in which the identifier is decoded from the QR code in the mobile multi-touch display device 30, and the decoded identifier is transmitted from there to association unit 40. However, it would also be possible, as a basic principle, that the image (the “pattern”) of the QR code detected by camera unit 31 be transmitted to association unit 40 and that the identifier not be decoded from the code until then.

As an alternative to the implementation described above, in which the medical image-based information system 100 is adapted to display the identifier on the image data display device 20₃ of the one or more image data display devices 20₁, 20₂, 20₃, the identifier may be also be applied to the housing, for example, e.g. in the form of a printed QR code, or near the image data display device 20₃ of the one or more image data display devices 20₁, 20₂, 20₃. Although such a solution is not as flexible as the first variant mentioned above, it is basically another possibility.

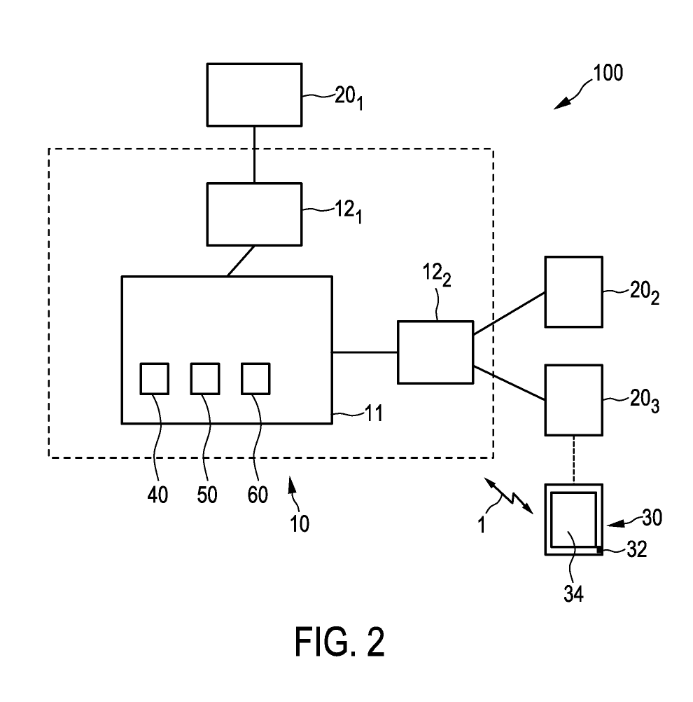

In a second embodiment, shown in FIG. 2, association unit 40 may be adapted to associate the mobile multi-touch display device 30 with the image data display device 20₃ of the one or more image data display devices 20₁, 20₂, 20₃ not—as described above—on the basis of a detected identifier, but based on the location of the mobile multi-touch display device 30. For that purpose, the medical image-based information system 100 includes a locating unit 50 for identifying the location of the mobile multi-touch display device 30. In one possible implementation, RFID (radio-frequency identification) technology can be used to that end. In this case, the mobile multi-touch display device 30 includes, for example, a suitable active or passive RFID transponder (not shown in FIG. 2), and locating unit 50 includes suitable reader devices (likewise not shown in FIG. 2) which can activate the RFID transponder by means of a radiated electromagnetic field and read out a “response” from the RFID transponder. In a suitable spatial arrangement of the reading devices, the location of the RFID transponder, and hence of the mobile multi-touch display device 30, can then be determined relative to the reading devices from time differences of arrival in the “response” of the RFID transponder. Alternatively or in addition to the use of RFID technology, locating unit 50 could also determine the location of the mobile multi-touch display device 30, where relevant, with the aid of the transmission and receiving means for wireless data communication between the processing unit 10 and the mobile multi-touch display device 30 (not shown in FIG. 2), as provided in the region of the processing unit 10, for example. In both cases, association unit 40 can associate the mobile multi-touch display device 30 with the image data display device 20₃ of the one or more image data display devices 20₁, 20₂, 20₃ whenever, for example, the distance of the mobile multi-touch display device 30 from the image data display device 20₃ of the one or more image data display devices 20₁, 20₂, 20₃ falls below a predetermined threshold value.

In the following, the description of the medical image-based information system 100 shall be continued with reference to the first embodiment shown in FIG. 1.

When the mobile multi-touch display device 30 is associated with the image data display device 20₃ of the one or more image data display devices 20₁, 20₂, 20₃ (this is indicated in FIG. 1 by the broken line connecting the two devices), the user can have the medical image data provided by processing unit 10 displayed on the associated image display device, in this case the high-resolution, certified monitor 20₃ at radiological workplace computer 12₂, and can interact with those data by means of the interactive functions made available via the mobile multi-touch display device 30. However, to prevent any unauthorized access to the medical image data, it is firstly necessary to authenticate the user properly before the medical image-based information system 100 is used. To that end, the mobile multi-touch display device 30 includes a sensor unit 32 for detecting a biometric identifier of the user, and the MIBIS 100 includes an authentication unit 60 for authenticating the user on the basis of a comparison of the detected biometric identifier with stored biometric identifiers of users authorized to use the MIBIS 100. In this embodiment, authentication unit 60 is implemented as part of processing unit 10, by means of suitable software routines, for example. Alternatively, authentication unit 60 can also be a separate, independent unit.

The authentication function described above is implemented in this embodiment by means of fingerprint recognition. In this case, sensor unit 32 is a fingerprint scanner which detects a finger print identifier, i.e., a digital image (“pattern”) of the user's fingerprint, for example. The detected fingerprint identifier is transmitted to authentication unit 60, which is adapted to authenticate the user on the basis of a comparison of the detected fingerprint identifier with stored fingerprint identifiers of users authorized to use the medical image-based information system 100. If the comparison shows that the detected fingerprint identifier can be assigned to one of the stored fingerprint identifiers, authentication is successful and the user is granted access to use the MIBIS 100. It should be understood that the fingerprint scanner is not limited to a particular type of scanner, such as an optical scanner, for example. Instead of an optical scanner, it is also possible to use a suitable ultrasound scanner, for example, or a capacitive scanner.

In another embodiment, sensor unit 32 can also be a camera that detects a digital image of the iris pattern or of the user's face. In this case, the detected biometric identifier is an iris pattern identifier and/or a face identifier. Many different implementations are conceivable here as well, for example an implementation using a normal camera that operates in the visible spectrum of light, or also one that uses an infrared camera additionally or alternatively thereto. The camera can also be a monoscopic camera, for example, or a stereoscopic camera, if necessary. It is also possible, basically, to use the camera unit 31 described above as sensor unit 32, which in this case would mean that just one single camera would be needed.

In this embodiment, the medical image-based information system 100 includes a de-authentication unit 70 for automatic de-authentication of the user. The mobile multi-touch display device 30 includes a motion tracking sensor 33, which captures motion data of the mobile multi-touch display device 30. The motion data are transmitted to de-authentication unit 70, which is adapted to authenticate the user on the basis of the captured motion data. This can be implemented, for example, by de-authentication unit 70 analyzing the captured motion data for “motion patterns” and then de-authenticating the user when, for example, the length of the total vector of movement of the mobile multi-touch display device 30 exceeds a predetermined threshold value after the user has been authenticated. (It can be assumed in this case that the user has distanced himself from the image data display device associated with the mobile multi-touch display device 30, in this case from the high-resolution, certified monitor 20₃ at radiological workplace computer 12₂.)

In the second embodiment, shown in FIG. 2, de-authentication unit 70 can be adapted not to de-authenticate the user on the basis of the captured motion data—as described above—but on the basis of the location of the mobile multi-touch display device 30. This location can be determined, as described above, by locating unit 50. De-authentication unit 70 can then de-authenticate the user when, for example, the distance of the mobile multi-touch display device 30 from the image data display device associated with the mobile multi-touch display device 30, in this case the high-resolution, certified monitor 20₃ at radiological workplace computer 12₂, exceeds a predetermined threshold value.

In the following, the description of the medical image-based information system 100 shall be continued with reference to the first embodiment shown in FIG. 1.

Users who are authorized to use the medical image-based information system 100 are classified in this embodiment into user classes, and the interactive functions made available to the user via mobile multi-touch display device 30 are dependent on the user class. One appropriate method of classification could be based, for example, on the type of medical work performed by the authorized user. In this case, there would be user classes such as “radiologist”, “pathologist”, “surgeon”, “general physician”, etc. A radiologist could then be provided, for example, with a different set of interactive functions to the one assigned to a surgeon, and a pathologist could be provided a different set of interactive functions to the set assigned to a general physician. Of course, other classifications are also possible in addition or alternatively, for example according to level of training or medical functions (“resident physician”, “consultant”, “senior physician”, “senior consultant”, “chief physician”, etc.). If other persons besides the medical personnel, such as nursing staff or administrative staff, are also allowed to use the MIBIS 100, such personnel can likewise be classified into respective user classes (such as “nurse”, “midwife”, “physiotherapist”, etc.), and interactive functions dependent on the respective user class can be provided to users in these user classes via the mobile multi-touch display device 30.

In addition to the classification of authorized users into user classes, the one or more image data display devices 20₁, 20₂, 20₃ are also classified in this embodiment into image data display device classes, and the interactive functions made available to the user via mobile multi-touch display device 30 are dependent not only on the user class, but also on the class of the image data display device. The classification of the one or more image data display devices 20₁, 20₂, 20₃ into the image data display device classes, as used here, is dependent on the operating environment in which the one or more image data display devices 20₁, 20₂, 20₃ are used. Conceivable examples include image data display device classes such as “radiological workplace”, “operating theater”, “patient's room”, “consulting room for the tumor board”, etc. These different operating environments generally differ not only with regard to the ambient parameters such as lighting conditions or ambient sound level, and the quality of the image data display devices 20₁, 20₂, 20₃ being used, but also with regard to the interactive functions that are usually needed in the respective operating environment.

For example, the entire set of interactive functions for analyzing and diagnosing the medical image data mobile multi-touch display device 30 could be provided at radiological workplace computer 12₂ with the two high-resolution, certified monitors 20₂, 20₃ to a corresponding user class (e.g. “radiologist”), whereas in a patient's room with suboptimal lighting conditions and a small, low-resolution monitor (not shown in FIG. 1), only a limited set of navigation and display functions would be made available via the mobile multi-touch display device 30 to the same (or a different) user. At the workplace computer 12₁ in the operating theater, on the other hand, a user from a respective user class (e.g. “surgeon”) could be provided with a set of functions for fetching and controlling special visualizations (e.g. to monitor the surgical operation) via the mobile multi-touch display device 30, and in a consulting room for an interdisciplinary tumor board (not shown in FIG. 1), special functions for annotating the medical image data via the mobile multi-touch display device 30 could be made available to users from different medical disciplines.

Alternatively or additionally, classification of the one or more image data display devices 20₁, 20₂, 20₃ into the image data display device classes may also be dependent on the quality of image data display on the one or more image data display devices 20₁, 20₂, 20₃. In this way, consideration could also be given to the fact that, in a particular operating environment, for example at radiological workplace computer 12₂, image data display devices may be provided that vary in their image data display quality.

In order to classify the image data display devices 20₁, 20₂, 20₃ into image data display device classes, the processing unit 10, in particular the central processing unit 11 and/or one or several of the decentralized processing units 12₁, 12₂, can comprise assignments between technical characteristics of the monitors 20₁, 20₂, 20₃ and the image data display device classes. The technical characteristics are, for instance, the size, the resolution, the orientation or another technical parameter of the respective monitor, and they are preferentially stored in the processing unit 10. If the multi-touch display device has been associated with a certain image data display device, the processing unit 10 can assign the associated image data display device to an image data display device class depending on the technical characteristics of the associated image data display and based on the assignments between the technical characteristics and the image data display device classes. Thus, an abstract description of potentially available image data display device classes can be predetermined, wherein the image data display device classes can be defined in terms of the technical characteristics of the image data display devices and wherein this abstract description can be used for classifying the image data display devices.

Further features of the medical image-based information system 100 shall now be described with reference to examples. It is assumed in this regard that a user in the “radiologist” user class would like to use the mobile multi-touch display device 30 in order to have medical image data of a patient displayed on the high-resolution, certified monitor 20₃ of radiological workplace computer 12₂, and in order to interact with those data by means of the interactive functions provided via the mobile multi-touch display device 30. To do this, the user first adjusts the mobile multi-touch display device 30 in this embodiment in such a way that camera unit 31 detects the identifier displayed on and assigned to the high-resolution, certified monitor 20₃ of radiological workplace computer 12₂. On the basis of the detected identifier, the mobile multi-touch display device 30 is then associated—as described in detail above—with the high-resolution, certified monitor 20₃ of radiological workplace computer 12₂. In addition, the user allows himself to be authenticated—as likewise described in detail above—by means of fingerprint recognition, so that he is granted permission to use the MIBIS 100.

In this embodiment, processing unit 10 now begins by transmitting information about available patient data, for example as a file, to the mobile multi-touch display device 30, which processes this information and displays it, for example, as a list of patients for selection, including thumbnails (i.e., small “preview” images of the associated medical image data), etc. The patient data transmitted to the mobile multi-touch display device 30 preferentially depend on, for instance, the location of the mobile multi-touch display device 30 and/or the authentication of the user. For instance, information about patient data can be transmitted only, which are allowed to be shown i) at the actual location of the mobile multi-touch display device 30 and/or ii) to the authenticated user holding the mobile multi-touch display device 30. As described above, the mobile multi-touch display device 30 is an electronic display device with a touch-sensitive screen 34 that is capable of detecting two or more points of simultaneous contact with the screen 24, for example with two fingers. When the user selects a set of patient data, for example by touching screen 34 at the place where the associated thumbnail is displayed, the mobile multi-touch display device 30 transmits an item of information relating to the selected patient data, for example an identifier, to processing unit 10, which then displays the associated medical image data on the image data display device associated with the mobile multi-touch display device 30, in this case on the high-resolution, certified monitor 20₃ of radiological workplace computer 12₂. If the selected patient data includes, for example, a series of medical image data, for which a workflow is defined, the medical image-based information system 100 switches in this embodiment into a “diagnosis” mode. The definition of the workflow can depend on the type of medical image data. For example, the workflow for mammography screening, mammography reading, magnetic resonance image (MRI) diagnosis etc. will be different. Also, the workflow may depend on the actual content of the image data in question, for example the workflow for routine diagnostic reading of MRI series will be different from the workflow for the preparation of interventions, for example with respect to the reporting tools offered. Also, the availability of workflows may be restricted by the user class and image display class at hand.

On screen 34, the mobile multi-touch display device 30 shows a number of (logically) independent areas of contact, and the medical image data are displayed on the high-resolution, certified monitor 20₃ of radiological workplace computer 12₂. A subset of the interactive functions provided via the multi-touch display device 30 is assigned to each of the displayed areas of contact. This assignment of the interactive functions provided via the multi-touch display device 30 can be configured in different ways, i.e., there can be variable definitions in this case, of which one of the interactive functions provided via the mobile multi-touch display device 30 can be performed with which points of contact in which area of contact. This can be implemented, for example, by programming the mobile multi-touch display device 30 accordingly. In this embodiment, the mobile multi-touch display device 30 transmits the detected points of contact to processing unit 10, which derives gestures of the user from them, with “permitted” gestures being allocated, in turn, to respective interactive functions. Alternatively, however, the gestures may also be derived directly by the mobile multi-touch display device 30 from the detected points of contact, with the derived gestures then being transmitted to processing unit 10.

If, for example, the intention is to perform measurements or segmentations in the medical image data, the mobile multi-touch display device 30 switches to a “processing” mode in which, for example, the outline of a woman's breast and important anatomical landmarks are displayed on the mobile multi-touch display device 30. The mobile multi-touch display device 30 also shows in symbolic form the annotations that can also be seen, where relevant, on the image data display device associated with the mobile multi-touch display device 30, in this case on the high-resolution, certified monitor 20₃ of radiological workplace computer 12₂. Thus, the mobile multi-touch display device 30 partly mirrors what the user sees and does on the “main monitor”.

The mobile multi-touch display device 30 also allows more natural interaction with the medical image data. This is advantageous, in particular, in the spatially oriented interactions that are often necessary when analyzing and diagnosing the medical image data, for example when performing spatial transformations of the medical image data, or when measuring distances (quantifications) in the medical image data. For example, distances in the medical image data can be measured simply and intuitively by a gesture in which the user, for example in a special “measurement” mode, spans two fingers apart and touches screen 34 of the mobile multi-touch display device 30 simultaneously at the two points between which he wants to measure the distance. However, it can be difficult to measure small distances when the two fingers are very close together, or even touch each other. In such a case, the medical image data on the image data display device associated with the mobile multi-touch display device 30, here the high-resolution, certified monitor 20₃ of radiological workplace computer 12₂, can be displayed automatically according to the distance between the fingers. In this way, it is possible to measure distances precisely. The starting point and the finishing point for measuring a distance are displayed on the “main monitor” and indicated on the mobile multi-touch display device 30. It is also possible, as a basic principle, to use particular gestures for different interactions, depending on the specific context.

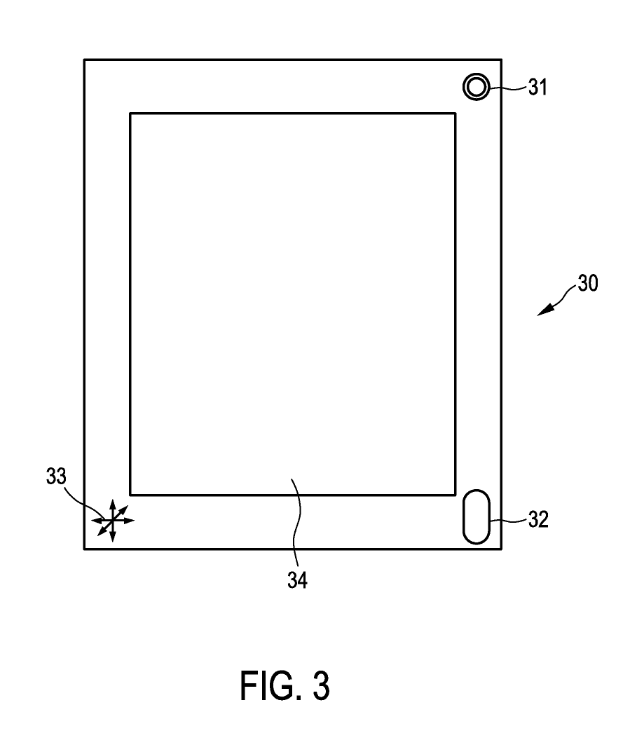

FIG. 3 shows, in schematic form and by way of example, an embodiment of a mobile multi-touch display device 30 for use in the medical image-based information system 100 according to the first embodiment shown in FIG. 1. In this embodiment, the mobile multi-touch display device 30 comprises a camera unit 31, a sensor unit 32, a motion tracking sensor 33 and a screen 34. The significance and the functions of these elements for using the mobile multi-touch display device 30 in the MIBIS 100, according to the first embodiment shown in FIG. 1, and the features of the mobile multi-touch display device 30 have already been described at length with reference to FIG. 1.

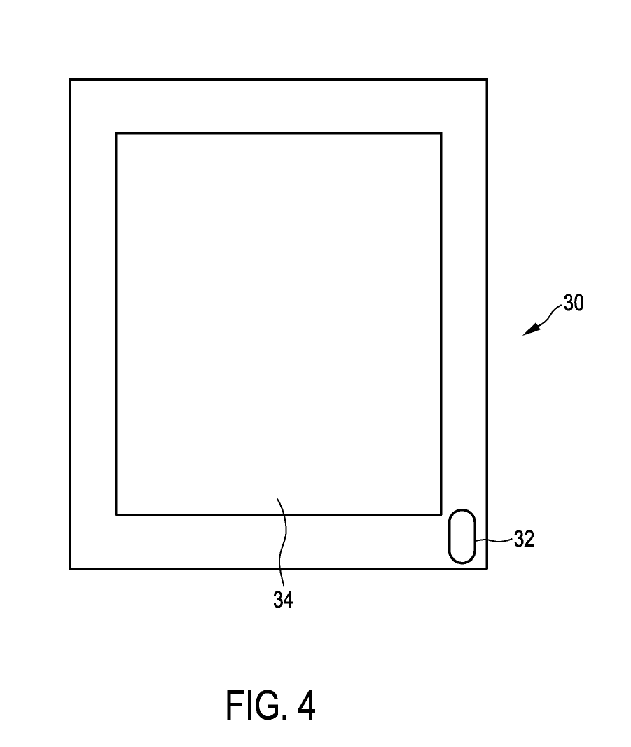

FIG. 4 shows, in schematic form and by way of example, an embodiment of a mobile multi-touch display device 30 for use in the medical image-based information system 100 according to the second embodiment shown in FIG. 2. In this embodiment, the mobile multi-touch display device 30 comprises a camera unit 31, a sensor unit 32 and a screen 34. The significance and the functions of these elements for using the mobile multi-touch display device 30 in the MIBIS 100, according to the second embodiment shown in FIG. 2, and the features of the mobile multi-touch display device 30 have already been described at length with reference to FIG. 2.

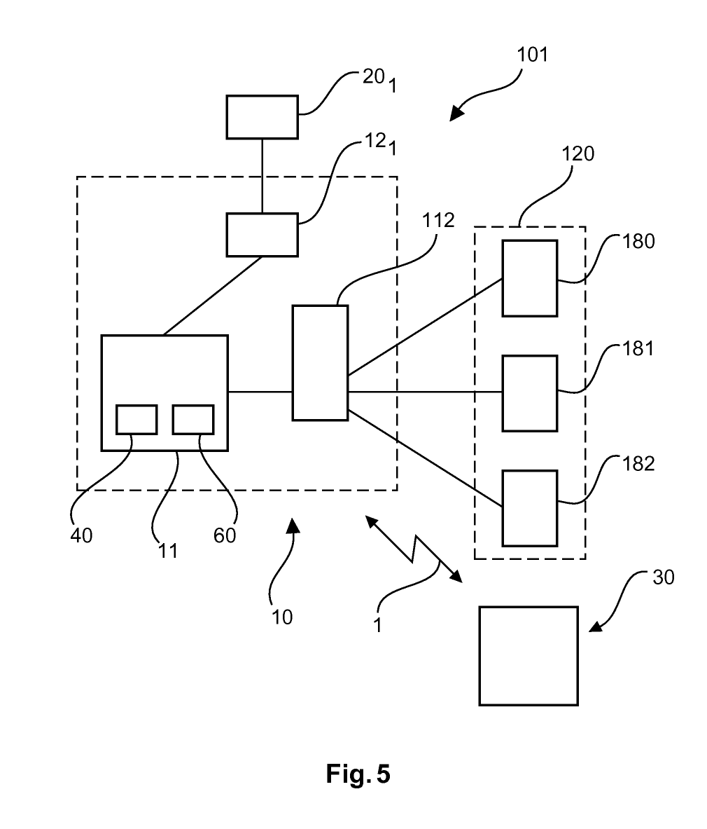

FIG. 5 shows schematically and exemplarily a further embodiment of a MIBIS. In this embodiment the MIBIS 101 also comprises a processing unit 10 for providing medical image data and interactive functions for interacting with the medical image data. The processing unit 10 is implemented in the form of a central processing unit 11 and a number of decentralized processing units 12₁, 112, which are connected via a network to central processing unit 11. The central processing unit 11 is similar to the central processing unit described above with reference to FIG. 1 and comprises, for instance, the association unit 40 and the authentication unit 60. The central processing unit 11 may comprise further units like the locating unit 50 described above with reference to FIG. 2. The decentralized processing units 12₁, 112 are similar to the decentralized processing units described above with reference to FIGS. 1 and 2, except for the connection of the decentralized processing unit 112 with an image data display device 120 comprising three monitors 180, 181, 182. The further image data display device 20₁ is formed by a single monitor connected to the decentralized processing unit 12₁.

As described above, the mobile multi-touch display device 30 can communicate with the processing unit 10 via a wireless data communication link 1.

If the mobile multi-touch display device 30 has been associated with the image data display device 120, for instance, by using an identifier on the image data display device 120 detectable by the mobile multi-touch display device 30, by using the location of the mobile multi-touch display device 30 relative to the image data display device 120, etc., the processing unit 10 can provide gestures via the mobile multi-touch display device 30 for controlling the different monitors 180, 181, 182 of the image data display device 120 and for switching from controlling one or several of the monitors 180, 181, 182 to controlling one or more other of the monitors 180, 181, 182. For instance, the image data display device 120 can comprise a first monitor 180 for showing MR images and second monitors 181, 182 for showing mammography images, wherein a first set of gestures can be provided for controlling the first monitor 180, a second set of gestures can be provided for controlling the second monitors 181, 182 and one or several third gestures can be provided for allowing a user to switch from controlling the first monitor 180 to controlling the second monitors 181, 182 and vice versa.

In an embodiment, the MIBIS can be adapted to achieve an optimal distribution of display viewports (i.e. the display areas in which images or other data, forms, etc. can be displayed or entered), for example, by using a set of definitions that characterize the required screen space, resolution, display class/type etc. for each predefined functionality (i.e. “mammography screening”, “mammography-MRI correlation”, “surgery preparation”, “patient round”), where a “functionality” comprises workflows, that consist of information items (images or other information, to display or to interact, that can be ranked into mandatory, optional, informative, etc.) together with a predefined sequence in which they have to be processed by the operator. Then, an arrangement is optimal when all mandatory information items can be displayed/offered for interaction, and as much as possible further information items can be provided. This determination of the optimal distribution can be performed, for instance, by the processing unit 10, particularly by the central processing unit 11 or a decentralized processing unit.

The MIBIS can also be adapted to select a template for a viewport arrangement from a predefined list of viewport arrangement templates based on a “best match” principle, where a score is assigned to each functionality that can successfully be assigned to an available viewport in that arrangement template, and by calculating the gross score for all available arrangement templates, and lastly selecting the best scoring arrangement template, or alternatively offer the top scoring arrangement templates to the operator to choose from. With available location information, the scores can additionally be ranked according to application scenario likelihoods (e.g. offer a surgery support arrangement template when surgery theater location is detected, etc.). Also this selection procedure can be performed, for instance, by the processing unit 10, particularly by the central processing unit 11 or a decentralized processing unit. Preferentially, for determining the score any operation can be used which results in a score for the arrangement templates.

The mobile multi-touch display device is connected to the processing unit via a wireless data connection link. Results of operations performed by using the respective image data display device, to which the mobile multi-touch display device is associated, can be stored in the processing unit 10, in particular in the central processing unit 11, which may be regarded as being a server, or in a decentralized processing unit to which the associated image data display device is connected. For instance, results of the diagnosis/processing/input of patients can be stored directly in the processing unit 10, rather than locally on the mobile multi-touch display device.

The MIBIS can be adapted such that a local storage and display of data can be provided on the mobile multi-touch display device. In particular, if the mobile multi-touch display device is associated with a certain image display device and if the association is lost, for instance, if the user goes away from the respective image data display device, data like image data, patient data, etc., which have lastly be shown, can be locally stored in the mobile multi-touch display device, to allow the user to review the image data and possibly other data like patient data, also if the user has gone away from the respective image data display device. If the user then approaches again the image data display device, results of operations performed on the mobile multi-touch display device can be transmitted to the processing unit 10 such that the results can be shown on the image data display device. If the user approaches another image data display device, which corresponds to another image data display device class, only the results may be shown on the image data display device, which are in conformance with the functions allowed on the image data display device. That the user goes away from the respective image data display device may be detected by using a localization mechanism like RFID. The multi-touch display device can also be adapted to allow the user to trigger the download of the data to the mobile multi-touch display device, if the authenticated user is allowed to do so. For example, the user may be allowed to download key images or requested parts of image series for offline review.

By looking at the drawings, the disclosure and the attached claims, other variations of the disclosed embodiments can be understood and carried out by a skilled person who is implementing the disclosure. It should be understood, in particular, that the invention is not limited to the two embodiments explicitly shown here. In one embodiment, for example, the associative function described in the foregoing can be based on the location of the mobile multi-touch display device 30 (cf. FIG. 2), whereas automatic de-authentication can be based on the detected motion data of the mobile multi-touch display device 30 (cf. FIG. 1). In this case, the mobile multi-touch display device 30 may also include a motion tracking sensor 33, for example.

In the claims, the words “comprise” and “include” do not exclude other elements or steps, and the indefinite article “a/an” does not exclude a plurality.

A single unit or device may perform the functions of several elements mentioned in the claims. For example, association unit 40 or authentication unit 60 may be implemented, as described above, as part of processing unit 10, for example by means of respective software routines. The fact individual functions and/or elements are mentioned in different dependent claims does not mean that a combination of these functions and/or elements could not also be used to advantage.

The reference signs in the claims are not to be understood as meaning that the subject-matter and the extent of protection conferred by the claims is limited by these reference signs.

Also, although certain terms are used primarily herein, other terms could be used interchangeably to yield equivalent embodiments and examples. In addition, terms may have alternate spellings which may or may not be explicitly mentioned, and all such variations of terms are intended to be included.

Furthermore, in some embodiments, some or all of the components may be implemented or provided in other manners, such as at least partially in software, firmware and/or hardware, including, but not limited to one or more application-specific integrated circuits (ASICs), standard integrated circuits, controllers executing appropriate instructions, and including microcontrollers and/or embedded controllers, field-programmable gate arrays (FPGAs), complex programmable logic devices (CPLDs), and the like. Some or all of the system components and/or data structures may also be stored as contents (e.g., as executable or other machine-readable software instructions or structured data) on a computer-readable medium (e.g., a hard disk; memory; network; other computer-readable medium; or other portable media article to be read by an appropriate drive or via an appropriate connection, such as a DVD or flash memory device) to enable the computer-readable medium to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames. Such computer program products may also take other forms in other embodiments. Accordingly, embodiments of this disclosure may be practiced with other computer system configurations.

All of the above U.S. patents, U.S. patent application publications, U.S. patent applications, foreign patents, foreign patent applications and non-patent publications referred to in this specification and/or listed in the Application Data Sheet, including but not limited to German Patent Application No. 10 2011 087 150.0, entitled “Medical image-based information system and mobile multitouch display device,” filed Nov. 25, 2011, is incorporated herein by reference, in its entirety.

From the foregoing it will be appreciated that, although specific embodiments have been described herein for purposes of illustration, various modifications may be made without deviating from the spirit and scope of the invention. For example, the methods and systems for performing herein are applicable to other architectures. Also, the methods and systems discussed herein are applicable to differing protocols, communication media (optical, wireless, cable, etc.) and devices (such as wireless handsets, electronic organizers, personal digital assistants, portable email machines, game machines, pagers, navigation devices such as GPS receivers, smart televisions, game controllers, etc.).

1. A medical image-based information system, wherein the medical image-based information system comprises:
a processing unit for providing medical image data and interactive functions for interacting with the medical image data;
one or more image data display devices for displaying the medical image data provided by the processing unit; and
a mobile multi-touch display device;
wherein the medical image-based information system is adapted to display the medical image data provided by the processing unit on an image data display device of the one or more image data display devices and to make the interactive functions provided by the processing unit available to a user via the mobile multi-touch display device.

2. The medical image-based information system according to claim 1, wherein the medical image-based information system includes an association unit for associating the mobile multi-touch display device with the image data display device of the one or more image data display devices.

3. The medical image-based information system according to claim 2, wherein the medical image-based information system is adapted to display on the image data display device of the one or more image data display devices an identifier assigned to said data display device, wherein the mobile multi-touch display device includes a camera unit for detecting the displayed identifier, and wherein the association unit is adapted to associate the mobile multi-touch display device with the image data display device of the one or more image data display devices on the basis of the detected identifier.

4. The medical image-based information system according to claim 2, wherein the medical image-based information system includes a locating unit for identifying the location of the mobile multi-touch display device, and wherein the association unit is adapted to associate the mobile multi-touch display device with the image data display device of the one or more image data display devices on the basis of the identified location.

5. The medical image-based information system according to claim 1, wherein the mobile multi-touch display device includes a sensor unit for detecting a biometric identifier of the user, and wherein the medical image-based information system includes an authentication unit for authenticating the user on the basis of a comparison of the detected biometric identifier with stored biometric identifiers of users authorized to use the medical image-based information system.

6. The medical image-based information system according to claim 5, wherein the detected biometric identifier is a fingerprint identifier, an iris pattern identifier or a face identifier.

7. The medical image-based information system according to claim 1, wherein users authorized to use the medical image-based information system are classified into user classes, and wherein the interactive functions made available to the user via the mobile multi-touch display device are dependent on the user class.

8. The medical image-based information system according to claim 1, wherein the medical image-based information system includes a de-authentication unit for automatic de-authentication of the user.

9. The medical image-based information system according to claim 1, wherein the one or more image data display devices are classified into image data display device classes, and wherein the interactive functions made available to the user via the mobile multi-touch display device are dependent on the image data display device class of the image data display device of the one or more image data display devices.

10. The medical image-based information system according to claim 9, wherein classification of the one or more image data display devices into the image data display device classes is dependent on an operating environment in which one or more image data display devices are used, and/or on the image data display quality of the one or more image data display devices.

11. The medical image-based information system according to claim 1, wherein the mobile multi-touch display device is adapted to receive an item of information from the processing unit about available patient data and to display this information in the form of a patient selection list for selection by the user.

12. The medical image-based information system according to claim 1, wherein the mobile multi-touch display device includes a touch-sensitive screen and is adapted to detect two or more points of simultaneous contact with the screen, and wherein the medical image-based information system is adapted to allow the user to perform the interactive functions made available via the mobile multi-touch display device by touching the screen.

13. The medical image-based information system according to claim 1, wherein the mobile multi-touch display device includes a touch-sensitive screen and is adapted to detect when the screen is touched at two or more places simultaneously and to transmit the detected points of contact to the processing unit.

14. The medical image-based information system according to claim 1, wherein the mobile multi-touch display device includes a touch-sensitive screen and is adapted to detect two or more points of simultaneous contact with the screen, wherein the mobile multi-touch display device is also adapted to display on the screen a number of independent areas of contact, each of which can be assigned to a subset of the interactive functions provided via the multi-touch display device.

15. The medical image-based information system according to claim 1, wherein the mobile multi-touch display device is adapted to communicate with the processing unit via a wireless data communication link.

16. A mobile multi-touch display device for use in the medical image-based information system comprising:
a communication module configured to communicate with a processing unit of a medical image-based information system to receive medical image data; and
an interface configured to provide interactive functions to a user for interacting with received medical image data.
